(19) United States
(12) Patent Application Publication
(10) Pub. No.: US 2024/0367574 A1
(43) Pub. Date: Nov. 7, 2024

(54) DEPLOYABLE KITCHEN WITH MOVABLE WALL AND ROOF STRUCTURES

(71) Applicant: Babington Technology, Inc., Rocky Mount, NC (US)

(72) Inventors: William Henry HAGUE, Deltona, FL (US); Andrew HAMER, Annapolis, MD (US); Joseph E. ROBB, Holly Springs, NC (US); Gary D. WASSON, Cadillac, MI (US)

(73) Assignee: Babington Technology, Inc., Rocky Mount, NC (US)

(21) Appl. No.: 18/643,630

(22) Filed: Apr. 23, 2024

Related U.S. Application Data
(60) Provisional application No. 63/463,164, filed on May 1, 2023.

(51) Int. Cl. B60P 3/025; B60P 3/34; E04B 1/343; E04B 1/344

(52) U.S. Cl. CPC B60P 3/0257; B60P 3/34; E04B 1/34336; E04B 1/3442

(57) ABSTRACT

A deployable facility includes an enclosure that has a first configuration with a first service volume and a second configuration with a second service volume. The second service volume is greater than the first service volume. The enclosure includes a fixed floor, a fixed roof, and a movable wing that is pivotably coupled to the fixed floor. The deployable facility also includes a covering support assembly that is pivotably coupled to the fixed roof. The covering support assembly has a collapsed configuration within the first service volume on a condition that the enclosure is in the first configuration and an expanded configuration within the second service volume on a condition that the enclosure is in the second configuration.

### CROSS-REFERENCE TO RELATED APPLICATIONS

This application claims benefit of priority to of U.S. Provisional Application Ser. No. 63/463,164, entitled “A Deployable Kitchen with Movable Wall and Roof Structures,” filed May 1, 2023, which is incorporated herein by reference in its entirety.

### STATEMENT REGARDING FEDERALLY SPONSORED RESEARCH OR DEVELOPMENT

This invention was made with government support under Other Transaction Authority for Prototype Agreement No. W911QY-19-9-0023 awarded by the Department of Defense (Natick Contracting Division). The government has certain rights in the invention.

### BACKGROUND

The embodiments described herein relate generally to deployable kitchens, and more particularly to deployable kitchens with movable wall and roof structures.

It is often necessary to cook for significant numbers of people at locations that do not have access to permanent kitchen facilities. For example, military units need deployable kitchens to support operations when personnel are deployed away from fixed facilities. Such deployable kitchens should be capable of preparing and feeding a large number of troops in a short period of time (e.g., more than 500 meals within less than three hours). Such deployable kitchens should also be energy efficient to conserve limited amounts of fuel, water, and other resources that may be available for field feeding. As another example, disaster relief operations need transportable kitchen appliances to provide food service for disaster zones and relief centers. Additionally, restaurants and caterers may use deployable kitchens to cook at remote locations, such as beaches, wooded areas, street fairs, etc.

Some known deployable kitchens include appliances for food preparation within a truck or trailer that can be transported to the area of need. Other known deployable kitchens can be housed within a standardized shipping container (e.g., a 20-ft International Organization for Standardization (ISO) container). Such deployable kitchens are referred to as containerized kitchens and can include movable walls (referred to as wings or wing walls) that allow for expanded space within the kitchen area when in the deployed configuration. The expanded space can be enclosed by a tent structure. Some known mechanisms for moving the wing walls include a manually actuated winch with complex cable routing. The wing walls and the known mechanisms for moving them can deteriorate over time due to exposure to the elements, repeated use, etc. Thus, a need exists for systems and methods of moving the movable walls and supporting the tent structure.

### SUMMARY

This summary introduces certain aspects of the embodiments described herein to provide a basic understanding. This summary is not an extensive overview of the inventive subject matter, and it is not intended to identify key or critical elements or to delineate the scope of the inventive subject matter.

In some embodiments, the deployable kitchen includes an enclosure that has a fixed floor and a fixed roof. The deployable kitchen also includes a movable wing pivotably coupled to the enclosure. The movable wing has an inner face separated from an outer face. A foldable covering is coupled between the inner face of the movable wing and the enclosure. The deployable kitchen further includes a motive assembly coupled to the fixed roof. The motive assembly is operably coupled to the outer face of the movable wing, such that actuation of the motive assembly transitions the movable wing between a first position and a second position.

In some embodiments, the inner face and the outer face at least partially define an internal volume of the movable wing.

In some embodiments, the movable wing includes a set of rib elements positioned within the internal volume. The rib elements are coupled between the inner face and the outer face of the movable wing to establish the separation between the inner face and the outer face.

In some embodiments, the movable wing has an absence of a core material positioned within the internal volume.

In some embodiments, the movable wing includes a first longitudinal edge and a second longitudinal edge. One of the first longitudinal edge or the second longitudinal edge defines at least one egress aperture in fluid communication with the internal volume. The egress aperture is configured to facilitate water egress from within the internal volume.

In some embodiments, the movable wing defines a longitudinal axis, and the motive assembly includes a tension member. In such embodiments, the movable wing includes an attachment structure coupled to the outer face within an attachment range. The motive assembly is operably coupled to the outer face of the movable wing via a removable coupling of the tension member to the attachment structure. The attachment structure includes a radius element positioned to preclude contact between an edge of the movable wing and the tension member of the motive assembly on a condition that the tension member is removably coupled to the attachment structure. The attachment range is centered at a midpoint of the longitudinal axis, and the attachment range is ten percent of a maximal longitudinal length of the movable wing.

In some embodiments, the movable wing defines a longitudinal axis, and the movable wing includes a first lateral edge positioned orthogonal to the longitudinal axis and a second lateral edge positioned orthogonal to the longitudinal axis. The first lateral edge defines a first cable orifice, and the second lateral edge defines a second cable orifice. The movable wing includes a cable passage positioned within the internal volume and in fluid communication with the first cable orifice and the second cable orifice. The cable passage is configured to facilitate passage of a lifting cable between the first cable orifice and the second cable orifice.

In some embodiments, a set of leveling jacks are pivotably coupled to the outer face. The set of leveling jacks are positioned substantially parallel to the outer face on a condition that the movable wing is at the first position and substantially orthogonal to the outer face on a condition that the movable wing is at the second position.

In some embodiments, the movable wing includes a set of retention brackets coupled to the outer face. The set of retention brackets is positioned to receive the set of level jacks on the condition that the movable wing is at the first position.

In some embodiments, the deployable kitchen includes at least one safety strap that has a first end coupled to the enclosure and a second end configured to be removably coupled to the movable wing on a condition that the movable wing is at the first position. The safety strap(s) has a length configured to establish an intermediate position of the movable wing that is between the first position and the second position.

In some embodiments, the first position of the movable wing is a wall position. The movable wing is substantially orthogonal to the fixed floor when positioned at the wall position. The outer face is configured as an exterior wall of the enclosure on a condition that the movable wing is at the wall position. The second position of the movable wing is a floor position. The movable wing is substantially parallel to the fixed floor when positioned at the floor position. The inner face is configured as a floor portion on a condition that the movable wing is at the floor position.

In some embodiments, the movable wing includes a first longitudinal edge and a second longitudinal edge. The movable wing is coupled to the enclosure at the second longitudinal edge, and the first longitudinal edge is positioned vertically above the second longitudinal edge on a condition that the movable wing is at the wall position.

In some embodiments, the movable wing extends along at least 95% of a longitudinal length of the enclosure.

In some embodiments, the motive assembly is a winch. The winch can be coupled to the fixed roof between the fixed roof and the fixed floor.

In some embodiments, the fixed roof defines a longitudinal axis of the enclosure. The winch is coupled to the fixed roof within a coupling range that is centered at a midpoint of the longitudinal axis of the enclosure. The coupling range is ten percent of a maximal longitudinal length of the enclosure.

In some embodiments, the winch includes a tension member surrounded by a chafe guard. The chafe guard precludes wearing of the tension member from contact with a portion of the enclosure, and a degradation of the tension member from ultraviolet light.

In some embodiments, the tension member includes a coupling portion. The coupling portion facilitates decoupling the tension member from the movable wing on a condition that the movable wing is at the first position.

In some embodiments, the deployable kitchen includes an enclosure that has a first configuration with a first service volume and a second configuration with a second service volume. The second service volume is greater than the first service volume. The enclosure includes a fixed floor, a fixed roof, and a movable wing pivotably coupled to the fixed floor. The deployable kitchen also includes a covering support assembly pivotably coupled to the fixed roof. The covering support assembly has a collapsed configuration within the first service volume on a condition that the enclosure is in the first configuration. The covering support assembly has an expanded configuration within the second service volume on a condition that the enclosure is in the second configuration.

In some embodiments, the covering support assembly includes a set of frame assemblies. Each frame assembly of the set of frame assemblies is pivotably coupled to the fixed roof and is configured to pivot relative to the fixed roof independently of at least one other frame assembly. The set of frame assemblies have a stored configuration within the first service volume on a condition that the enclosure is in the first configuration and a support configuration within the second service volume on a condition that the enclosure is in the second configuration.

In some embodiments, each frame assembly of the set of frame assemblies includes a movable roof segment and a support member. The movable roof segment has an inboard end portion pivotably coupled to the fixed roof and an outboard end portion separated from the inboard end portion by a longitudinal length of the movable roof segment. The support member includes a pivot end that is movably coupled to the outboard end portion of the movable roof segment. The support member includes a coupling end positioned opposite the pivot end. The coupling end is configured to be removably coupled to the movable wing on a condition that the enclosure is in the second configuration.

In some embodiments, on a condition that the frame assembly is in the stored configuration, a longitudinal axis of the support member is substantially parallel to a longitudinal axis of the movable roof segment, a portion of the support member is retained by a securing bracket coupled to the movable roof segment, and a ceiling face of the movable roof segment is directed toward a longitudinal midline of the enclosure. On a condition that the covering support assembly is in the support configuration, the outboard end portion of the movable roof segment is vertically lower than the inboard end portion of the movable roof segment, the longitudinal axis of the support member has an angle relative to the face that is greater than 90 degrees, the longitudinal axis of the support member has an angle relative to the fixed floor of less than 90 degrees, and the ceiling face of the movable roof segment is directed toward the movable wing.

In some embodiments, the movable roof segment includes at least one rigid panel.

In some embodiments, the movable roof segment is an insulating structure configured to restrict a thermal transmission through the movable roof segment.

In some embodiments, the movable roof segment is translucent.

In some embodiments, the inboard end portion of the movable roof segment defines a clearance passage that is configured to receive a sealing flange of the enclosure on a condition that the frame assembly is in the support configuration.

In some embodiments, the movable wing has an inner face separated from an outer face. The movable wing is at a wall position and the outer face is configured as an exterior wall of the enclosure on a condition that the enclosure is in the first configuration. The movable wing is at a floor position and the inner face is configured as a floor portion on a condition that the enclosure is in the second configuration. The covering support assembly is removably coupled to the inner face on a condition that the movable wing is at the floor position.

In some embodiments, a foldable covering is coupled between the movable wing and the fixed roof. A movable roof segment of the covering support assembly is positioned between the foldable covering and an inner face of the movable wing on a condition that the enclosure is in the second configuration.

In some embodiments, the foldable covering is positioned between the movable wing and the fixed roof on a condition that the enclosure is in the first configuration.

In some embodiments, the foldable covering is positioned between the movable wing and the covering support assembly in the collapsed configuration on a condition that the enclosure is in the first configuration.

In some embodiments, the foldable covering is a fabric enclosure.

In some embodiments, the deployable kitchen includes a motive assembly coupled to the fixed roof. The motive assembly is operably coupled to an outer face of the movable wing to pivot the movable wing relative to the fixed floor.

In some embodiments, the motive assembly includes a tension member. The motive assembly is operably coupled to the outer face of the movable wing via a removable coupling of the tension member to the outer face. The foldable covering is positioned between the tension member and the second service volume on a condition that the enclosure is in the second configuration.

In some embodiments, the enclosure includes a sealing flange. The sealing flange has at least one surface that contacts a corresponding sealing surface of the movable wing to substantially seal the first service volume on a condition that the enclosure is in the first configuration. The sealing flange is positioned between the fixed roof and the fixed floor.

In some embodiments, the sealing flange is between the sealing surface of the movable wing and the covering support assembly on the condition that the enclosure is in the first configuration.

### BRIEF DESCRIPTION OF THE DRAWINGS

FIGS. 1 and 2 are perspective views of a deployable facility (i.e., a deployable kitchen) according to an embodiment, in a first (i.e., storage) configuration (FIG. 1) and a second (i.e., deployed) configuration (FIG. 2).

FIG. 3 is a perspective view of a movable wing of the deployable facility shown in FIGS. 1 and 2 depicting the movable wing at a first position.

FIG. 4 is a top view schematic illustration of a portion of a deployable facility, according to an embodiment, showing a portion of a fixed floor and the movable wing shown in FIG. 3 at a second position.

FIG. 5 is a close-up perspective view of a portion of the movable wing shown in FIG. 3.

FIG. 6 is a perspective view of a safety strap coupled between the movable wing shown in FIG. 3 and an enclosure of the deployable facility shown in FIGS. 1 and 2.

FIG. 7 is a perspective view of the movable wing shown in FIG. 3 and an enclosure of the deployable facility shown in FIGS. 1 and 2 depicting the movable wing at an intermediate position.

FIG. 8 is a perspective view of the deployable facility shown in FIG. 2 depicting the movable wing at a second position with a foldable covering in a partially folded configuration.

FIG. 9 is a perspective view of the deployable facility shown in FIG. 2 depicting the movable wing at the second position with the foldable covering in an expanded configuration.

FIG. 10 is a perspective view of a portion of the interior of the deployable facility shown in FIG. 2.

FIG. 11 is a perspective view of the deployable facility shown in FIG. 2 with the foldable covering removed and a covering support assembly in a collapsed configuration according to an embodiment.

FIGS. 12 and 13 are perspective views of the deployable facility shown in FIG. 2 with the foldable covering removed depicting frame assemblies of the covering support assembly in a support configuration according to an embodiment.

FIG. 14 is a perspective view of the deployable facility shown in FIG. 2 with the foldable covering removed depicting the covering support assembly in an expanded configuration according to an embodiment.

FIG. 15 is a side view of a frame assembly shown in FIGS. 12 and 13 in the collapsed configuration.

FIG. 16 is a close-up side view of a portion of a frame assembly shown in FIGS. 12 and 13 in the collapsed configuration.

FIG. 17 is a side view of a frame assembly shown in FIGS. 12-14 in the expanded configuration.

FIG. 18 is a close-up side view of a portion of the frame assembly shown in FIGS. 12-14 in the expanded configuration.

FIG. 19 is an enlarged view of a portion of the movable wing shown in FIG. 3 identified by the region x₁ in FIG. 7 depicting a swivel guide according to an embodiment.

FIG. 20 is a front view of the swivel guide of FIG. 19.

### DETAILED DESCRIPTION

The embodiments described herein relate to deployable facilities, such as a deployable kitchen, a deployable shelter, a deployable living habitat, a deployable medical facility, a deployable command and control facility, a deployable educational facility, and/or a deployable logistics facility. Insofar as the systems and methods described herein can be used with any suitable deployable facility, in the interest of clarity, the systems and methods are described with reference to a deployable kitchen.

The deployable kitchen includes an enclosure, such as a standardized shipping container, that has a fixed floor, fixed roof, and at least one movable wing. The enclosure has a first configuration (e.g., a shipping configuration) that has a first service volume. In the first configuration, the enclosure can be transported via a trailer, a truck, a railcar, a ship, and/or an aircraft. Once positioned at the deployed location, the deployable kitchen can be transitioned to a second configuration (e.g., a deployed configuration) that has a second service volume that is greater than the first service volume. For example, in some embodiments, the movable wing can be rotated from a wall position to a floor position and a foldable covering (e.g., a fabric portion) can be expanded and supported by a covering support assembly. The covering support assembly remains pivotably coupled to the fixed roof when the enclosure is in the first configuration, the second configuration, and any configuration therebetween. The volume enclosed by the foldable covering and the enclosure can define the second service volume of the enclosure in the second configuration. The second service volume can, for example, be approximately double the first service volume and an embodiment wherein the enclosure has a single movable wall. However, in an embodiment wherein the enclosure has a pair of movable walls, the second service volume can be approximately triple the first service volume.

The embodiments described herein can be included in any suitable deployable kitchen including food trucks, mobile kitchen trailers (such as the wheeled kitchens shown and described in U.S. Pat. No. 10,322,661 entitled “Mobile Kitchen,” which is incorporated herein by reference in its entirety), self-contained deployable kitchens (such as the containerized kitchens used by the U.S. Army), deployable kitchens that are connectable to external power sources (such as the expeditionary field kitchens used by the U.S. Marine Corps), and any other suitable structure that includes one or more cooking appliances that can deployed.

As used herein, the term “about” when used in connection with a referenced numeric indication means the referenced numeric indication plus or minus up to 10% of that referenced numeric indication. For example, the language “about 50” covers the range of 45 to 55. Similarly, the language “about 5” covers the range of 4.5 to 5.5.

In addition, the singular forms “a”, “an”, and “the” are intended to include the plural forms as well, unless the context indicates otherwise. The terms “comprises”, “includes”, “has”, and the like specify the presence of stated features, steps, operations, elements, components, etc. but do not preclude the presence or addition of one or more other features, steps, operations, elements, components, or groups.

As used herein, specific words chosen to describe one or more embodiments and optional elements or features are not intended to limit the invention. For example, spatially relative terms—such as “beneath”, “below”, “lower”, “above”, “upper”, “proximal”, “distal”, and the like—may be used to describe the relationship of one element or feature to another element or feature as illustrated in the figures. These spatially relative terms are intended to encompass different positions (i.e., translational placements) and orientations (i.e., rotational placements) of a device in use or operation in addition to the position and orientation shown in the figures. For example, if a device in the figures is turned over, elements described as “below” or “beneath” other elements or features would then be “above” or “over” the other elements or features. Thus, the term “below” can encompass both positions and orientations of above and below. A device may be otherwise oriented (e.g., rotated 90 degrees or at other orientations) and the spatially relative descriptors used herein interpreted accordingly. Likewise, descriptions of movement along (translation) and around (rotation) various axes include various spatial device positions and orientations.

Similarly, geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round”, a component that is not precisely circular (e.g., one that is slightly oblong or is a many-sided polygon) is still encompassed by this description.

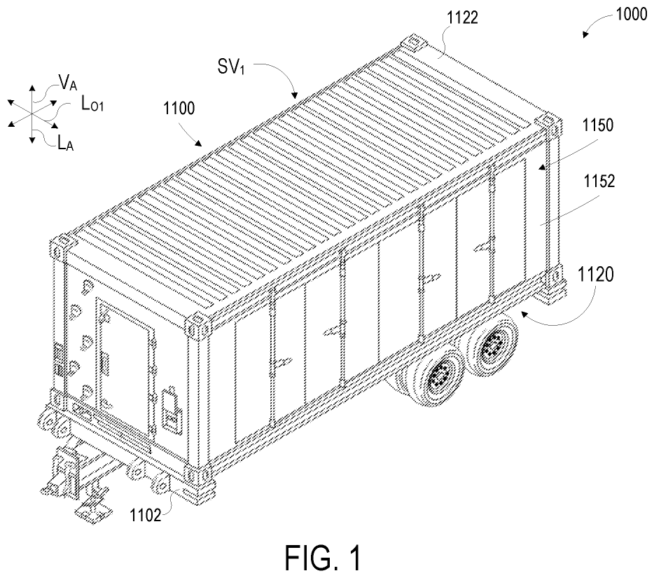

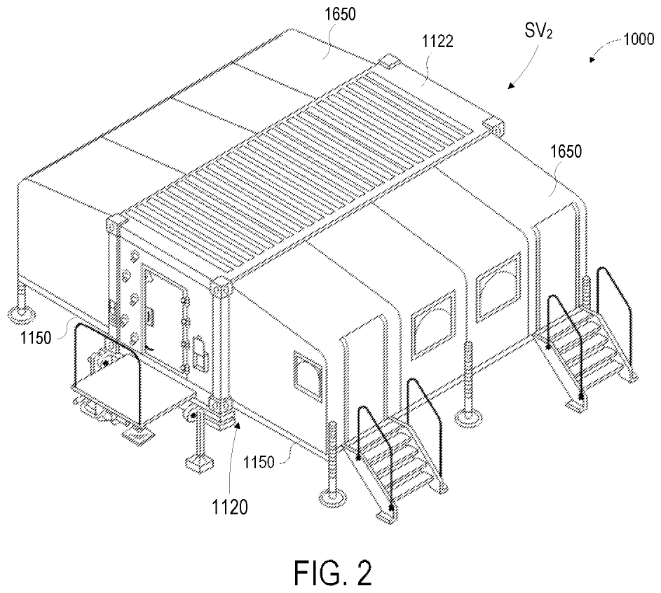

FIGS. 1-18 depict various features and elements of a deployable facility configured as a deployable kitchen 1000. For example, FIGS. 1 and 2 are perspective views of the deployable kitchen 1000, according to an embodiment. The deployable kitchen 1000 is configured to transition between a first (undeployed) configuration (FIG. 1) and a second (i.e., deployed) configuration (FIG. 2). When in the undeployed configuration, the deployable kitchen 1000 can be stored or transported (e.g., via ship, trailer transport, aircraft shipping, or any other suitable method of transport) for later use. Said another way, in some embodiments the deployable kitchen 1000 (e.g., a deployable field kitchen) is suitable for transport between a first location and a second location (e.g., between a garrison location and a field location). In the first configuration depicted in FIG. 1, the deployable kitchen 1000 has a first service (or storage) volume SV₁. When in the deployed configuration FIG. 2, the deployable kitchen 1000 can be expanded to provide a second service volume SV₂ (e.g., a service region) for meal preparation and distribution services.

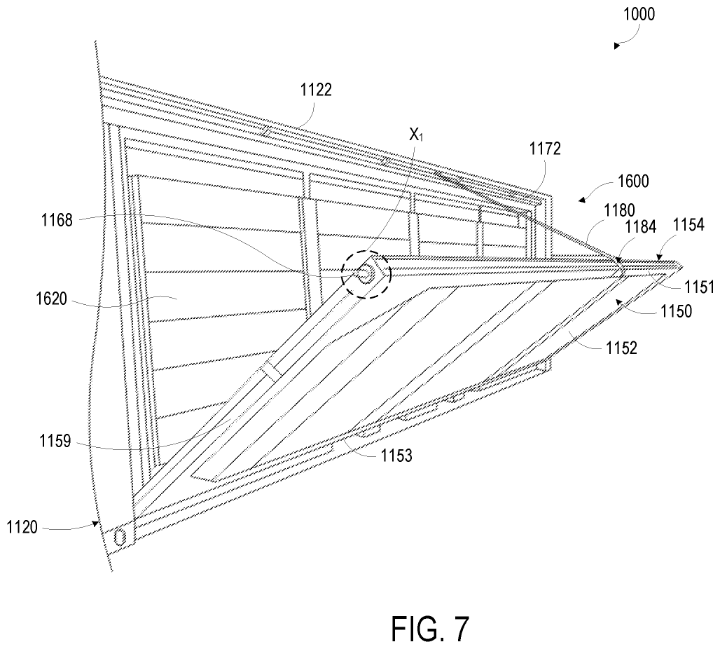

The deployable kitchen 1000 includes an enclosure 1100 that is configured to contain equipment for performing a desired function (e.g., at least one cooking appliance, a sanitation station, and/or other suitable food service components). As depicted, the enclosure 1100 includes a fixed floor 1120, a fixed roof 1122, and movable wings 1150 (e.g., wing walls). In some embodiments, the deployable kitchen 1000 includes a foldable covering 1650 that is coupled between the fixed roof 1122 and the movable wing 1150. In some embodiments, the foldable covering 1650 overlays and is supported by a covering support assembly 1600 (FIG. 7, foldable covering removed for clarity). Referring to FIG. 1, the enclosure 1100 defines a longitudinal axis (L_{O1}), a lateral axis (L_{A}), and a vertical axis (V_{A}).

In some embodiments, the enclosure 1100 is constructed to meet the dimensional requirements of ISO Standards 661 and 1161 when the enclosure is in the first configuration. In this manner the deployable kitchen 1000 can be easily transported by truck, rail, sea, or air. Moreover, the enclosure can be constructed from materials and can have the moisture sealing and structural integrity to comply with Coast Guard requirements for shipment by sea, and arrangement in a stacked configuration.

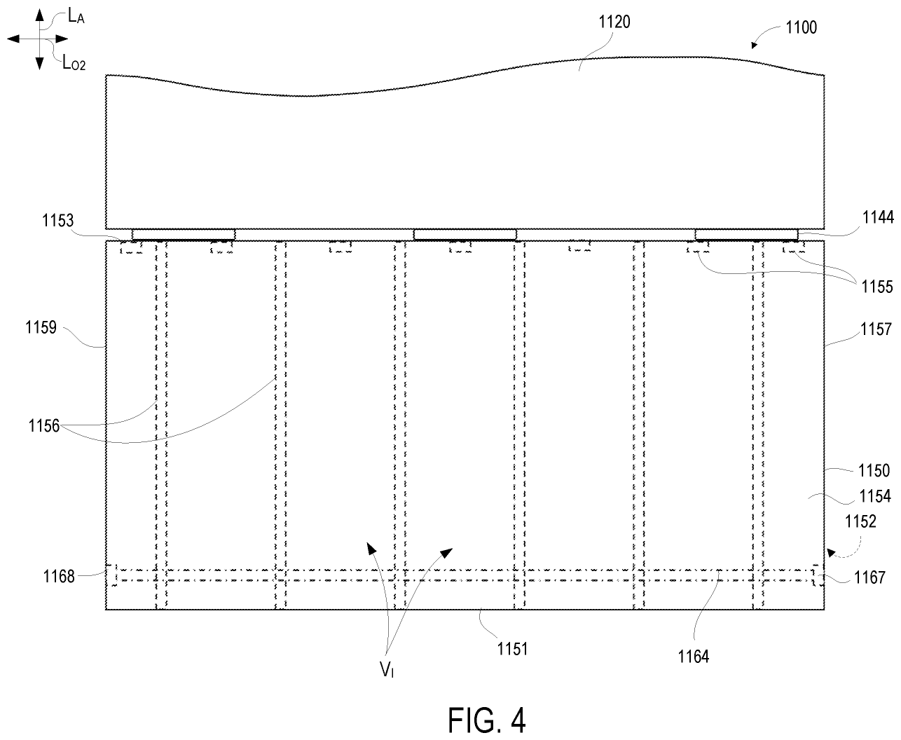

Referring now to FIGS. 1-9, in some embodiments, the movable wing 1150 is a wall structure that is pivotably mounted to the enclosure 1100, which allows for the enclosure 1100 (and the deployable kitchen 1000) to move between the first configuration (FIG. 1) and the second configuration (FIG. 2). In some embodiments, the movable wing extends along at least 90% (e.g., at least 95%) of the longitudinal length of the enclosure 1100. In some embodiments, the movable wing 1150 is coupled to the fixed floor 1120 by a set of hinges 1144 (FIG. 4). In this manner, the movable wing 1150 can move relative to the fixed floor 1120 between a wall position (FIG. 1) and a floor position (FIG. 2). In some embodiments, the movable wing 1150 can be coupled to the fixed roof 1122 such that the movable wing 1150 can move relative to the fixed roof between the wall position and a roof position (not shown). Although described herein with reference to a single movable wing 1150, the deployable kitchen 1000 can include additional movable wings 1150 (e.g., two movable wings) such as depicted in FIG. 2.

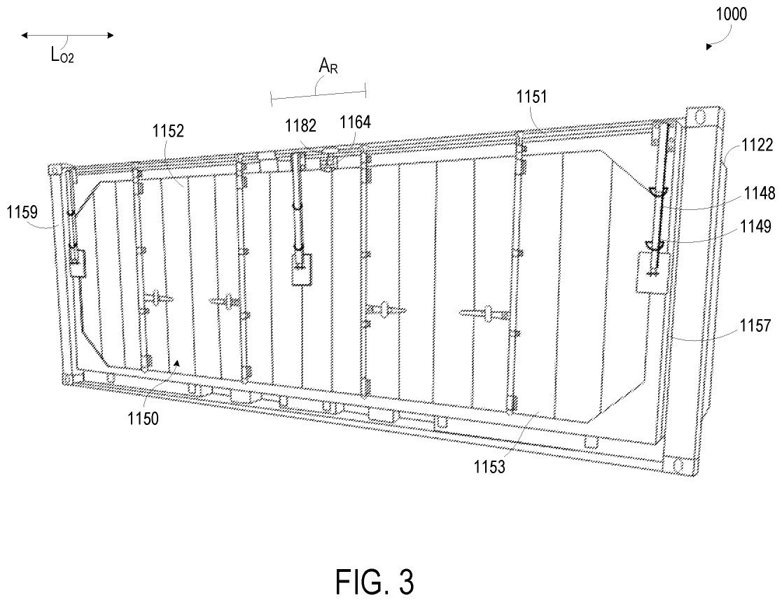

As depicted in FIGS. 1 and 3, in some embodiments the first position of the movable wing 1150 is a wall position. When at the wall position, the movable wing 1150 is substantially orthogonal to the fixed floor 1120. The outer face 1152 of the movable wing 1150 is configured as an exterior wall of the enclosure 1100 on a condition that the movable wing 1150 is at the wall position as depicted in FIGS. 1 and 3.

As depicted, for example, in FIGS. 2, 4, 8, and 9, the second position of the movable wing 1150 is a floor position in some embodiments. When positioned at the floor position, the movable wing 1150 is substantially parallel to the fixed for 1120 of the enclosure 1100. The inner face 1154 is configured as a floor portion on a condition that the movable wing 1150 is at the floor position. Accordingly, the inner face 1154 can include a non-slip coating.

The movable wing 1150 includes an outer face 1152 separated from an inner face 1154. The inner face 1154 and the outer face 1152 define an internal volume V_{I} of the movable wing 1150. In some embodiments, the internal volume V_{I} is substantially equal to the surface area of the inner face 1154 multiplied by a thickness of the movable wing 1150. In some embodiments, the movable wing 1150 includes a set of rib elements 1156 (FIG. 4) positioned within the internal volume V_{I}. The set of rib elements 1156 are coupled between the inner face 1154 and the outer face 1152 of the movable wing 1150. Accordingly, the set of rib elements 1156 establish the separation between the inner face 1154 and the outer face 1152. In other words, the set of rib elements 1156 can establish the thickness of the movable wing 1150. In some embodiments, the set of rib elements 1156 are positioned orthogonal to a longitudinal axis L_{O2} of the movable wing 1150.

In some embodiments, the movable wing 1150 can be a stressed-skin structure. Additionally, in some embodiments, the movable wing 1150 can be a skin-on-frame structure. Further, in some embodiments, the movable skin can be a combination of a stressed-skin structure and a skin-on-frame structure. As depicted in FIG. 4, the movable wing 1150 has an absence of a core material positioned within the internal volume V_{I}. For example, the internal volume V_{I} is constructed with an absence of a foam core, a plywood core, a corrugated core, and/or other similar core material. The absence of the core material can reduce the weight of the movable wing 1150, preclude absorption of water by a core material, and/or facilitate the drainage of water from the internal volume V_{I}.

As depicted in FIGS. 3 and 4, in some embodiments the movable wing 1150 includes a first longitudinal edge 1151 and a second longitudinal edge 1153. In some embodiments, the movable wing 1150 is coupled to the enclosure 1100 at the second longitudinal edge 1153. In such embodiments, the first longitudinal edge 1151 is positioned vertically above the second longitudinal edge 1153 on a condition that the movable wing 1150 is at the wall position as depicted in FIG. 3.

In some embodiments, the movable wing 1150 (e.g., one of the first longitudinal edge 1151 or the second longitudinal edge 1153) defines at least one egress aperture 1155 as depicted in FIG. 4. The egress aperture(s) 1155 is in fluid communication with the internal volume V_{I}. The egress aperture(s) 1155 is configured to facilitate water egress from within the internal volume V_{I}. As such, the longitudinal edge that defines the egress aperture(s) 1155 can be shaped (e.g., sloped and/or grooved) to direct a portion of water within the internal volume V_{I} toward the egress aperture(s) 1155 for discharge to the exterior volume surrounding the deployable kitchen 1000. The egress aperture(s) 1155 can be configured to be sealed when the movable wing 1150 is at the second position. For example, in some embodiments, the movable wing 1150 can include one or more removable plugs (not shown) that can be used to seal the egress aperture(s) 1155.

As depicted in FIGS. 4 and 7, in some embodiments the movable wing 1150 includes a first lateral edge 1157 and a second lateral edge 1159. The first lateral edge 1157 and the second lateral edge 1159 are positioned orthogonal to the longitudinal axis Log of the movable wing 1150. In some embodiments, the first lateral edge 1157 can define a first cable orifice 1167, and the second lateral edge 1159 can define a second cable orifice 1168. The first cable orifice 1167 and the second cable orifice 1168 can be configured to receive a lifting cable (e.g., a wire, a braided cable, rope, and/or other similar structure) (not shown). The movable wing, in some embodiments, can also include a cable passage 1169. The cable passage 1169 can be positioned within the internal volume V_{I} and in fluid communication with the first cable orifice 1167 and the second cable orifice 1168. The cable passage 1169 is configured to facilitate passage of the lifting cable between the first cable orifice 1167 and the second cable orifice 1168. The cable passage 1169 facilitates the use of the movable wing 1150 with enclosures that are equipped with a side-mounted manual winch.

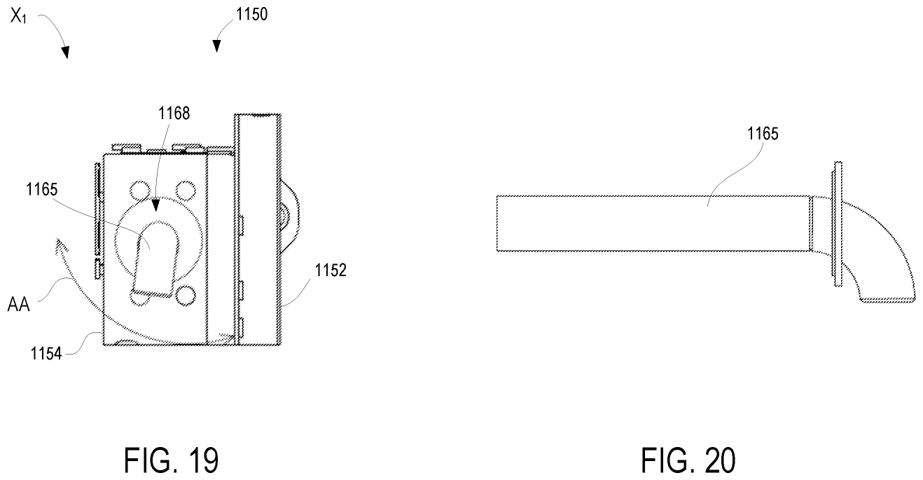

In some embodiments, the movable wing 1150 includes a guide structure 1165 as depicted in FIGS. 19 and 20. The guide structure 1165 can be positioned within the second cable orifice 1168. However, in some embodiments, the wing structure can include a guide structure 1165 positioned in each of the first cable orifice 1167 and the second cable orifice 1168. In some embodiments, a portion of the guide structure 1165 can surround a portion of the cable passage 1169. As depicted in FIG. 19, The cable guide structure 1165 is pivotable relative to the inner face 1154 of the movable wing 1150 along the arrow AA. As such, the cable guide structure 1165 is configured to maintain an orientation relative to the enclosure 1100 (e.g., to a point of intersection between the lifting cable and the enclosure). The cable guide structure 1165 has a radius that establishes a maximum bend of the lifting cable passing therethrough during a movement of the movable wing 1150. The pivotability and the radius of the cable guide structure 1165 reduce or preclude an abrasion of the lifting cable during the movement of the movable wing 1150.

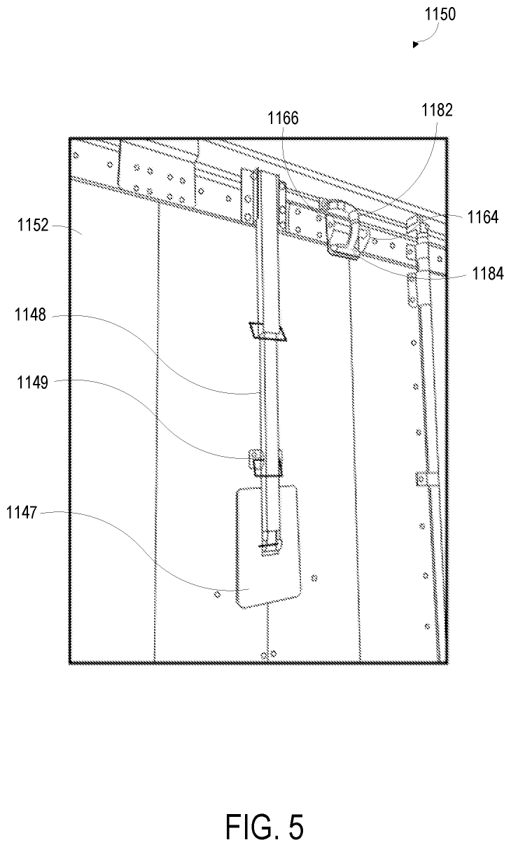

As depicted in FIGS. 3 and 5, in some embodiments a set of leveling jacks 1148 are pivotably coupled to the outer face 1152 of the movable wing 1150. The leveling jacks 1148 are pivotally coupled to the outer face 1152 on a condition that the movable wing 1150 is in the first position, the second position, and any positions therebetween. Said another way, as the leveling jacks 1148 remain coupled to the outer face 1152 regardless of the position of the movable wing 1150, the leveling jacks 1148 can be used to establish the movable wing 1150 in the floor position without further coupling therebetween. The leveling jacks 1148 are positioned substantially parallel to the outer face 1152 on a condition that the movable wing 1150 is at the first position as depicted in FIG. 3. As such, in some embodiments, the movable wing 1150 includes a set of retention brackets 1149 coupled to the outer face 1152. The retention brackets 1149 are positioned to receive each of the leveling jacks 1148 on the condition that the movable wing 1150 is at the first position (e.g., the wall position). The retention brackets 1149 are configured to preclude an inadvertent pivoting of the leveling jacks 1148 away from the outer face 1152. The leveling jacks 1148 are positioned substantially orthogonal to the outer face 1152 on a condition that the movable wing 1150 is at the second position. The leveling jacks 1148 have an adjustable length that facilitates supporting the movable wing 1150 in the presence of an uneven support surface. A contact plate 1147 is coupled to an end of each of the leveling jacks 1148. The contact plate 1147 configured to contact the support surface and distributed a load to the support surface on a condition that the movable wing 1150 is at the second position. The contact plate 1147 has an area that is greater than a lateral cross-sectional area of the corresponding leveling jack 1148.

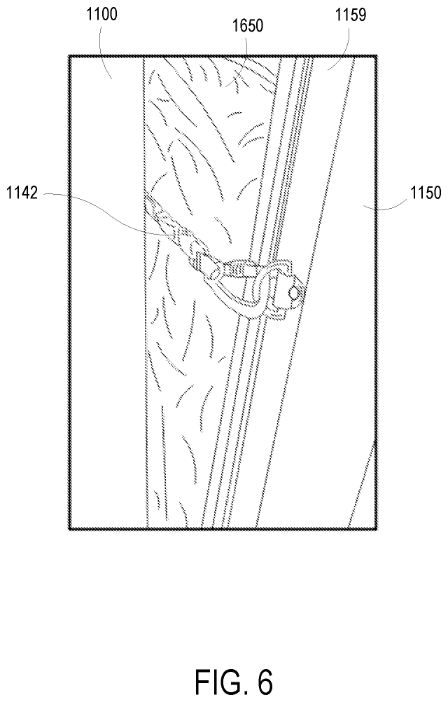

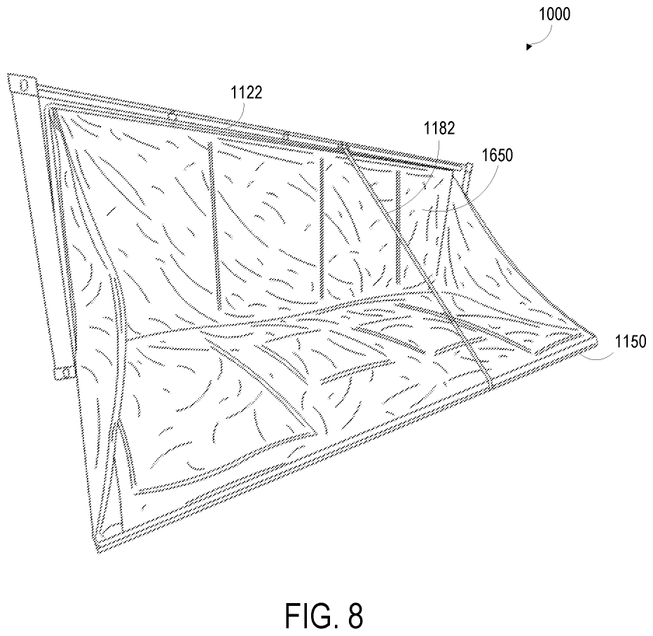

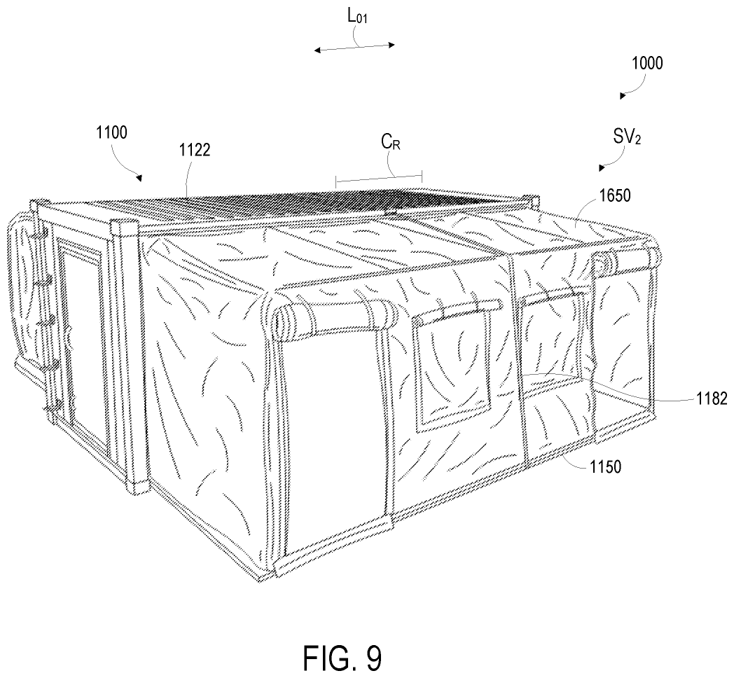

As depicted in FIG. 6, in some embodiments the deployable kitchen 1000 includes at least one safety strap 1142. The safety strap 1142 has a first end coupled to the enclosure 1100 and a second end configured to be removably coupled to the movable wing 1150 (e.g., to the second lateral edge 1159). The second end can, for example, include a locking clasp or other similar structure. The safety strap 1142 can be configured to be removably coupled to the movable wing 1150 on a condition that the movable wing 1150 is at the first position (e.g., the wall position). The safety strap 1142 has a length that is configured to establish an intermediate position of the movable wing 1150 as depicted in FIG. 6. The intermediate position of the movable wing 1150 is between the first position, as depicted in FIG. 3, and the second position, as depicted in FIGS. 8 and 9. The safety strap 1142 can preclude an inadvertent lowering of the movable wing 1150 from the wall position to the floor position. In operation, the safety strap 1142 can be decoupled from the movable wing 1150 following confirmation that the path of the movable wing 1150 is free from obstructions and the leveling jacks 1148 (if to be used) have been released from the retention brackets 1149.

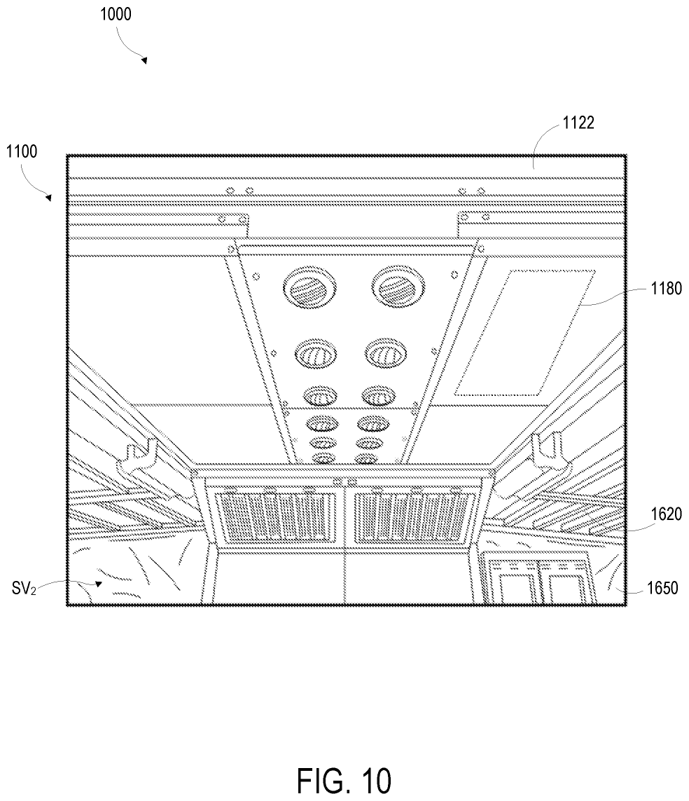

In some embodiments, the deployable kitchen 1000 includes a motive assembly 1180 (shown schematically in FIG. 10). The motive assembly 1180 is coupled to the fixed roof 1122. The motive assembly 1180 can, for example, be a winch. The winch can be an electric winch, an externally powered winch, a manual winch, a hydraulic winch, an air winch and/or other similar mechanism configured to exert a tensile load on the movable wing 1150 to pivot the movable wing 1150 relative to the enclosure 1100. In this embodiment, the motive assembly 1180 is operably coupled to the outer face 1152 of the movable wing 1150. An actuation of the motive assembly 1180 transitions the movable wing 1150 between the first position (FIG. 3) and the second position (FIGS. 8 and 9). For example, the motive assembly 1180 can lower the movable wing 1150 from the wall position to the floor position via a transitional state as depicted in FIG. 7 (foldable covering removed for clarity). In some embodiments, the motive assembly 1180 can be a single motive assembly configured to apply a tensile force to more than one movable wing 1150. For example, in some embodiments, a single motive assembly 1180 can be used to simultaneously (or separately) transition a pair of movable wings 1150 between the wall position and the floor position. In additional embodiments, however, the deployable kitchen 1000 can include more than one motive assembly 1180 with each motive assembly 1180 being operably coupled to a different movable wing 1150. As such, each motive assembly 1180 can independently transition the corresponding movable wing 1150 between the first position and the second position.

As depicted in FIG. 10, in some embodiments, the motive assembly 1180 is coupled to the fixed roof 1122 between the fixed roof 1122 and the fixed floor 1120. In other words, in some embodiments the motive assembly 1180 is positioned within the first service volume SV₁ (e.g., the interior of the enclosure 1100). Said another way, the motive assembly 1180 can be coupled to a ceiling portion of the fixed roof 1122, such as behind an access panel. In some embodiments, the fixed roof 1122 defines the longitudinal axis L_{O1} of the enclosure 1100. The motive assembly 1180 (e.g., the winch) is coupled to the fixed roof 1122 within a coupling range CR (FIG. 9). The coupling range CR is centered at a midpoint of the longitudinal axis L_{O1}. The coupling range CR is 10% of a maximal longitudinal length of the enclosure 1100. Said another way, the motive assembly 1180 is coupled to the fixed roof 1122 at a point that is no more than 5% of the maximal longitudinal length away from the longitudinal midpoint of the fixed roof 1122.

In some embodiments, the motive assembly 1180 includes a tension member 1182. The tension member 1182 can, as depicted in FIGS. 8 and 9, be routed external to the foldable covering 1650. Said another way, the foldable covering 1650 is positioned between the tension member 1182 and the second service volume SV₂ on a condition that the enclosure 1100 is in the second configuration. The tension member 1182 can be a synthetic cable, a rope, a steel cable, a strap, and/or other suitable structure. In some embodiments, the tension member 1182 can be surrounded by a chafe guard. The chafe guard can preclude the wearing of the tension member 1182 due to contact with a portion of the enclosure 1100. Additionally, the chafe guard can preclude degradation of the tension member 1182 due to exposure to ultraviolet light or other environmental conditions. Accordingly, the inclusion of the chafe guard surrounding the tension member 1182 can prolong the lifecycle of the tension member 1182.

As depicted in FIG. 5, in some embodiments, the tension member 1182 includes a coupling portion 1184. The coupling portion 1184 facilitates coupling and decoupling the tension member 1182 from the movable wing 1150. For example, the coupling portion 1184 can facilitate decoupling the tension member 1182 from the movable wing 1150 on a condition that the movable wing 1150 is at the first position (e.g., the wall position). In some embodiments, the motive assembly 1180 is operably coupled to the outer face 1152 of the movable wing 1150 via the removable coupling of the tension member 1182 to an attachment structure 1164 (FIG. 5) coupled to the outer face 1152 of the movable wing 1150. The attachment structure 1164 is coupled to the outer face 1152 within an attachment range AR (FIG. 3). The attachment range AR is centered at a midpoint of the longitudinal axis L_{O2} of the movable wing 1150. The attachment range AR can, for example, be 10% or less of the maximal longitudinal length of the movable wing 1150. In other words, the attachment structure 1164 can be displaced from the longitudinal midpoint of the movable wing 1150 by no more than 5% of the maximal longitudinal length of the movable wing 1150. This arrangement allows the tension applied from the tension member 1182 to be substantially evenly applied between the lateral edges of the movable wing 1150. In some embodiments, the attachment structure 1164 includes a radius element 1166 that is positioned to preclude contact between an edge of the movable wing 1150 and the tension member 1182 on a condition that the tension member 1182 is movably coupled to the attachment structure 1164.

FIG. 8 depicts the movable wing 1150 in the floor position while the foldable covering 1650 is in a partially folded configuration. In FIG. 9, the movable wing 1150 is in the floor position and the foldable covering 1650 is in a service configuration. On a condition that the foldable covering 1650 is in the service configuration as depicted in FIG. 9, the foldable covering 1650 and the enclosure 1100 define the second service volume SV₂. On a condition that the enclosure 1100 is in the first configuration (e.g., the stored configuration), the foldable covering 1650 is positioned between the movable wing 1150 and the fixed roof 1122. In some embodiments, the foldable covering 1650 is a fabric enclosure (e.g., a material produced by weaving or knitting fibers). However, in some embodiments, the foldable covering 1650 can include a number of rigid or semi rigid segments coupled together via a set of flexible joints.

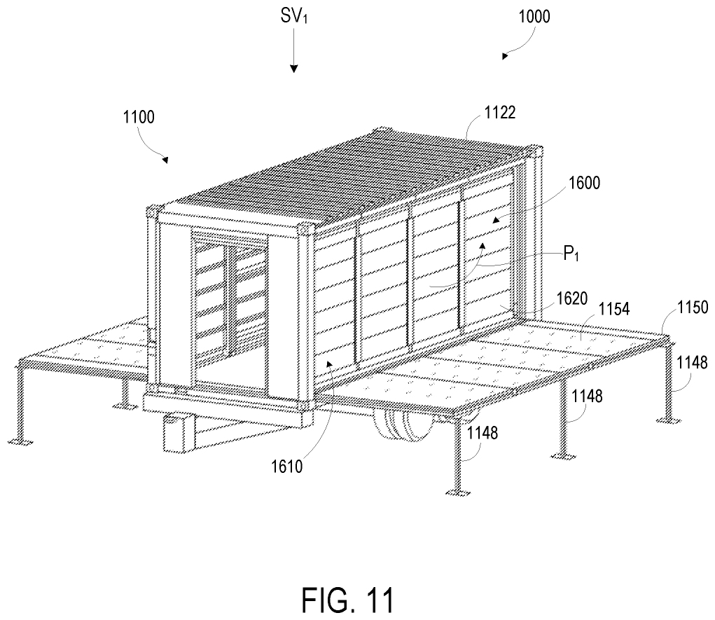

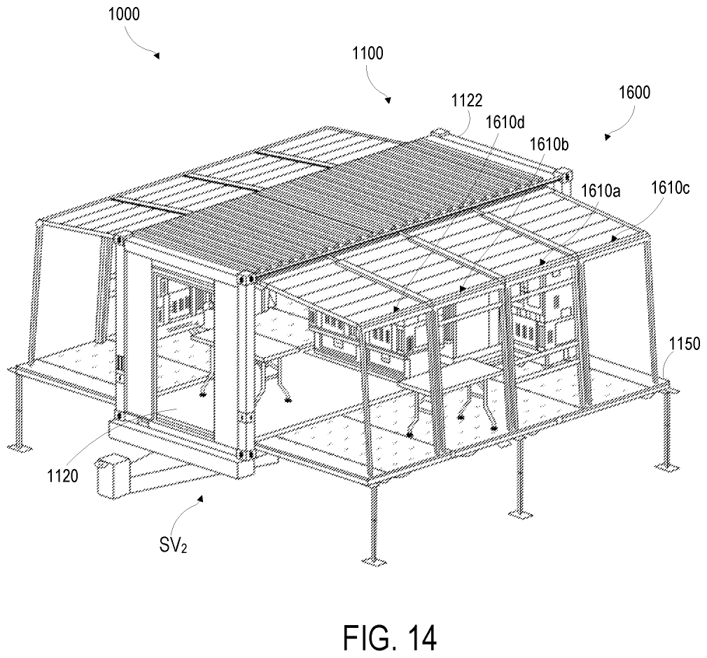

As depicted in FIGS. 7 and 11-14, in some embodiments the deployable kitchen 1000 includes a covering support assembly 1600. The coupling support assembly 1600 is pivotably coupled to the fixed roof 1122. The covering support assembly 1600 remains pivotably coupled to the fixed roof 1122 on a condition that the enclosure is in the first configuration, the second configuration, and all configurations therebetween. In other words, the covering support assembly 1600 contrasts with a removable pole assembly in that the covering support assembly 1600 is not removed from the enclosure 1100 on a transition from the second configuration to the first configuration. To facilitate remaining pivotably coupled to the fixed roof 1122 in all configurations of the enclosure 1100, the coupling support assembly 1600 has a collapsed configuration (as depicted in FIGS. 7 and 11) within the first service volume SV₁ on a condition that the enclosure is in the first configuration and an expanded configuration (as depicted in FIG. 14) within the second service volume SV₂ on a condition that the enclosure 1100 is in the second configuration. Said another way, the covering support assembly 1600 is collapsed to be within the volume defined by the enclosure 1100 when the movable wing 1150 is in the wall position and is expanded to be within the volume defined by the combination of the foldable covering 1650 and the enclosure 1100 when the movable wing 1150 is in the floor position. In the expanded configuration, the covering support assembly 1600 is configured to maintain the foldable covering 1650 in the service configuration as depicted in FIG. 9. In FIGS. 7 and 11-14, the foldable covering is omitted for clarity. However, in some embodiments, the covering support assembly 1600 can be employed in the absence of a foldable covering. For example, in some embodiments the covering support assembly 1600 can be used to shade personnel and/or equipment supported by the inner face 1154 without necessitating the use of a foldable covering.

As depicted in FIGS. 7 and 11, in some embodiments the covering support assembly 1600 has a longitudinal length that is substantially equal to the longitudinal length of the movable wing 1150. The covering support assembly 1600 has a surface area that is substantially equal to the surface area of the inner face 1154. As depicted in FIG. 11, on a condition that the covering support assembly 1600 is in the collapsed configuration and the movable wing 1150 is in the floor position, the covering support assembly 1600 is substantially orthogonal to the inner face 1154.

The covering support assembly 1600 includes a set of frame assemblies 1610. In some embodiments, the covering support assembly 1600 can include four frame assemblies 1610a, 1610b, 1610c, and 1610d distributed along a longitudinal length of the fixed roof 1122 as depicted in FIG. 14. However, in some embodiments, the covering support assembly 1600 can include any number of frame assemblies 1610. For example, in an embodiment wherein the deployable kitchen 1000 includes a pair of movable wings, the covering support assembly 1600 can include eight frame assemblies.

Each frame assembly 1610 is pivotably coupled to the fixed roof 1122. Each frame assembly 1610 has a stored configuration within the first service volume SV₁ on a condition that the enclosure 1100 is in the first configuration (e.g., a stored or shipping configuration). Each frame assembly 1610 has a support configuration (e.g., unfolded, extended, or expanded configuration) on a condition that the enclosure 1100 is in the second configuration (e.g., a deployed or service configuration). Each frame assembly 1610 is configured to transition between the stored configuration and the support configuration by pivoting relative to the fixed roof 1122. For example, each frame assembly 1610 is configured to transition from the stored configuration to the support configuration by pivoting relative to the fixed roof 1122 along the path indicated by arrow P₁ (FIG. 11). Each frame assembly 1610 is configured to pivot relative to the fixed roof 1122 independently of at least one other frame assembly 1610. Each frame assembly 1610 can include restrictive features and markings configured to establish an order in which each frame assembly 1610 can be pivoted relative to the fixed roof 1122.

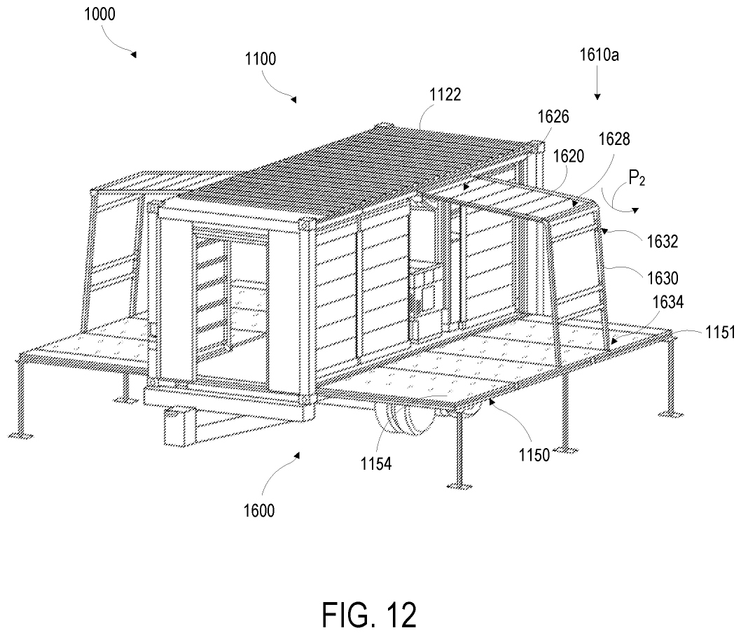

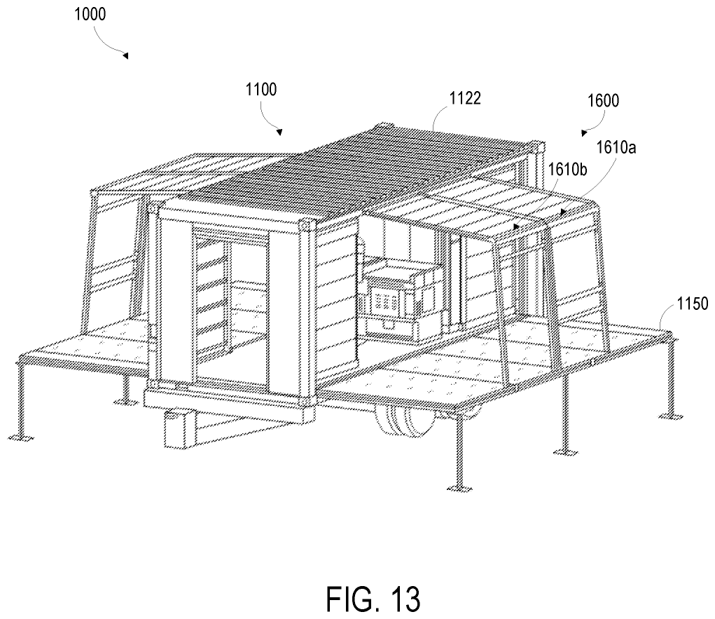

FIG. 11-14 depicts a transition of the covering support assembly 1600 from the collapsed configuration (FIG. 11) to the expanded configuration (FIG. 14) with the foldable covering removed for clarity. FIG. 11 depicts each frame assembly 1610 of the covering support assembly 1600 in the stored configuration, while the movable wing 1150 is depicted in the floor position. In FIG. 11, each frame assembly 1610 is depicted as hanging vertically downward from the fixed roof 1122. To transition the covering support assembly 1600 to the expanded configuration, FIG. 12 depicts a first frame assembly 1610a after being pivoted relative to the fixed roof 1122 in the direction of the arrow P₁ and, as described more fully below, a support members 1630 being pivoted relative to a movable roof segment 1620 in the direction of the arrow P₂ to transition the first frame assembly 1610a to the support configuration. FIG. 13 depicts an intermediate step in the transition of the covering support assembly 1600 to the expanded configuration in which a second frame assembly 1610b has been pivoted, such as in accordance with the order established by the restrictive features and markings, to transition to the support configuration. FIG. 14 depicts the covering support assembly 1600 in the expanded configuration following the transition of a third frame assembly 1610c and a fourth frame assembly 1610d to the support configuration. In some embodiments, the transition of the covering support assembly 1600 to the expanded configuration establishes and supports the foldable covering 1650 in the service configuration. In some embodiments, however, the covering support assembly 1600 can be transitioned to the expanded configuration in the absence of the foldable covering 1650. It should be appreciated that the covering support assembly 1600 can be transitioned from the expanded configuration to the collapsed configuration by reversing the depicted process.

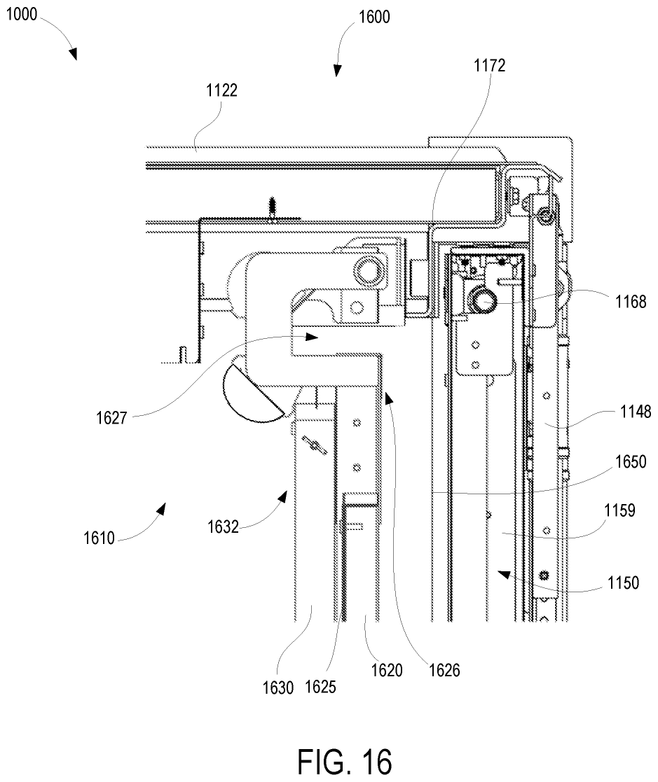

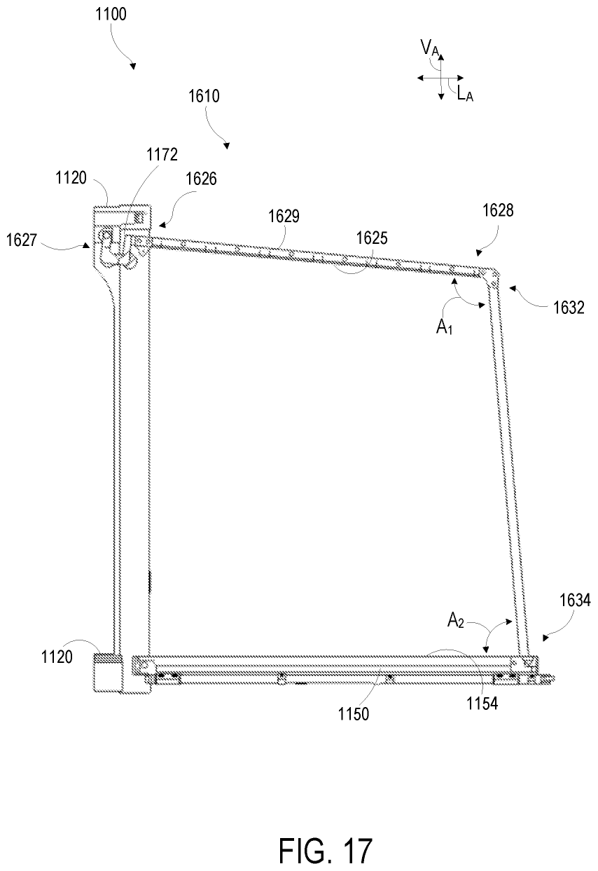

Referring now to FIGS. 12-18, each frame assembly 1610 of the covering support assembly 1600 includes a movable roof segment 1620 and a support member 1630 pivotably coupled thereto. The support member 1630 can, for example, be a leg or a pair of legs, or other similar member configured to position the movable roof segment 1620. The movable roof segment 1620 is configured to be positioned between the foldable covering 1650 and the inner face 1154 of the movable wing 1150 on a condition that the enclosure 1100 is in the second configuration. The movable roof segment 1620 can have a ceiling face 1625 oriented toward the inner face 1154 and a support face 1629 oriented away from the inner face 1154 on a condition that the frame assembly 1610 is in the support configuration. The movable roof segment 1620 has an inboard end portion 1626 that is pivotably coupled to the fixed roof 1122. The movable roof segment 1620 has an outboard end portion 1628 separated from the inboard end portion 1626 by a longitudinal length. The movable roof segment 1620 can, for example, be a panel structure with a longitudinal length substantially equal to a vertical distance between the fixed roof 1122 and the fixed floor 1120 of the enclosure and a lateral width that is substantially equal to 25% of the longitudinal length of the inner face 1154 of the movable wing 1150. In some embodiments, the movable roof segment 1620 is an insulating structure (e.g., panel) configured to restrict a thermal and/or auditory transmission through the movable roof segment 1620. In some embodiments, the movable roof segment 1620 is translucent. In some embodiments, lighting structures can be coupled to the inboard end portion 1626 such that the lighting structures can transition between a first position (FIG. 16) and a second position (FIG. 17) via the pivoting of the frame assembly 1610 relative to the fixed roof 1122.

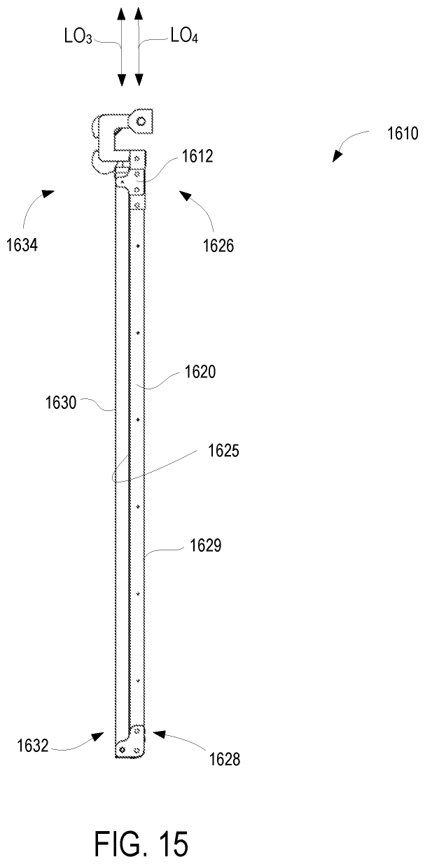

As depicted in FIGS. 12 and 15, the support member 1630 includes a pivot end 1632. The pivot end 1632 is movably coupled to the outboard end portion 1628 of the movable roof segment 1620. The support member can include a coupling end 1634 positioned opposite the pivot in 1632. The coupling end 1634 can be configured to be removably coupled from the movable wing 1150 on a condition that the enclosure is in the second configuration. The coupling end 1634 can, for example, include a pin, a peg, a magnet, a tenon, a latch, and/or other structure configured to removably couple the support member 1630 to the inner face 1154 so as to fix the position of the support member 1630 relative to the movable wing 1150. The support member 1630 is configured to transfer a compressive load from the movable roof segment 1620 to the movable wing 1150. In some embodiments, the longitudinal length of the support member 1630 can be altered via an adjustment mechanism of the support member 1630.

FIG. 15 depicts the frame assembly 1610 in the stored configuration. In the stored configuration, a longitudinal axis L_{O3} of the support member 1630 is substantially parallel to a longitudinal axis L_{O4} of the movable roof segment 1620. In this configuration, the coupling end 1634 is positioned in closer proximity to the inboard end portion 1626 of the movable roof segment 1620 than to the outboard end portion 1628. In some embodiments, a portion of the support member 1630 is retained by a securing bracket 1612 coupled to the movable roof segment 1620. For example, in some embodiments, the securing bracket 1612 can be coupled to the inboard end portion 1626 and the coupling end 1634 can be secured by the securing bracket 1612 on a condition that the frame assembly 1610 is in the stored condition. Additionally, as depicted in FIG. 16, in the stored configuration, a ceiling face 1625 of the movable roof segment 1620 is directed toward a longitudinal midline of the enclosure 1100. Said another way, in the stored condition, the movable roof segment 1620 is in a substantially vertical orientation with the ceiling face 1625 directed toward the first service volume SV₁ defined by the enclosure 1100.

FIG. 17 depicts the frame assembly 1610 in the support configuration. In the support configuration, the outboard end portion 1628 of the movable roof segment 1620 is vertically lower than the inboard end portion 1626 of the movable roof segment 1620. Said another way, in the support configuration, the movable roof segment 1620 sloped away from the fixed roof 1122 of the enclosure 1100 along the lateral axis L_{A}. The longitudinal axis L_{O3} of the support member 1630 defines a first angle A₁ relative to the ceiling face 1625 that is greater than 90 degrees. The longitudinal axis L_{O3} of the support member 1630 also defines a second angle A₂ relative to the fixed floor 1120 of less than 90 degrees. Additionally, the ceiling face 1625 of the movable roof segment 1620 is directed toward the movable wing 1150.

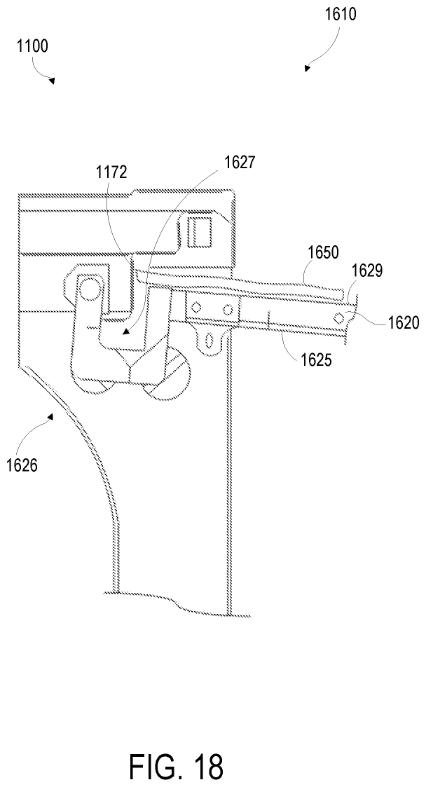

As depicted in FIGS. 7 and 16-18, in some embodiments, the enclosure 1100 includes a sealing flange 1172. The sealing flange 1172 has at least one surface that contacts a corresponding sealing surface of the movable wing 1150 to substantially seal the first service volume SV₁ on a condition that the enclosure 1100 is in the first configuration. The sealing flange 1172 is positioned between the fixed roof 1122 and the fixed floor 1120. As depicted in FIGS. 17 and 18, the inboard end portion 1626 of the movable roof segment 1620 defines a clearance passage 1627. The clearance passage 1627 is configured to receive the sealing flange 1172 of the enclosure 1100 on a condition that the frame assembly 1610 is in the support configuration. Said another way, the clearance passage 1627 precludes interference between the sealing flange 1172 and the movable roof segment 1620. This configuration allows the movable roof segment 1620 to be at a maximal height position (relative to the fixed floor and/or the movable wing) on condition that the frame assembly 1610 is in the support configuration. In this manner, the size of the second service volume SV₂ can be maximized (e.g., to accommodate tall personnel).

As depicted in FIG. 16, in some embodiments, the sealing flange 1172 is between the scaling surface of the movable wing 1150 and the covering support assembly 1600 on the condition that the enclosure 1100 is in the first configuration (e.g., with the movable wing 1150 in the wall position as depicted in FIG. 1). As further depicted in FIG. 16, in some embodiments, the foldable covering 1650 is positioned between the movable wing 1150 and the covering support assembly 1600 in the collapsed configuration on the condition that the first enclosure is in the first configuration.

The components of any of the deployable facilities described herein can be constructed from any suitable material or combination of material. For example, the structures described herein can be constructed from stainless steel, aluminum, composites, woven fibers, or any other metal or combination of metals suitable for the described functions. In some embodiments, any of the structures described herein can include a surface coating formulated to reduce corrosion that may result due to exposure to water and/or environmental conditions.

While some embodiments have been described above, it should be understood that they have been presented by way of example only, and not limitation. Where methods and/or schematics described above indicate certain events and/or flow patterns occurring in certain order, the ordering of certain events and/or operations may be modified. While the embodiments have been particularly shown and described, it will be understood that various changes in form and details may be made.

Although some embodiments have been described as having particular features and/or combinations of components, other embodiments are possible having a combination of any features and/or components from any of embodiments as discussed above. Aspects have been described in the general context of deployable kitchens, but inventive aspects are not necessarily limited to use in deployable kitchens. For example, in some embodiments, any of the movable wings, support structures or other components described herein can be used in connection with any deployable service enclosure. Such deployable service enclosures can include enclosures that contain manufacturing or fabrication equipment, laboratory equipment (e.g., to allow for portable diagnostic tests to be conducted), or computing equipment.

1. A deployable kitchen, comprising:
an enclosure having a fixed floor and a fixed roof;
a movable wing pivotably coupled to the enclosure, the movable wing having an inner face separated from an outer face;
a foldable covering coupled between the inner face of the movable wing and the enclosure; and
a motive assembly coupled to the fixed roof, the motive assembly being operably coupled to the outer face of the movable wing, such that actuation of the motive assembly transitions the movable wing between a first position and a second position.

2. The deployable kitchen of claim 1, wherein:
the inner face and the outer face at least partially define an internal volume of the movable wing.

3. The deployable kitchen of claim 2, wherein:
the movable wing includes a plurality of rib elements positioned within the internal volume;
the plurality of rib elements is coupled between the inner face and the outer face of the movable wing to establish the separation between the inner face and the outer face; and
the movable wing has an absence of a core material positioned within the internal volume.

4. (canceled)

5. The deployable kitchen of claim 2, wherein:
the movable wing includes a first longitudinal edge and a second longitudinal edge;
one of the first longitudinal edge or the second longitudinal edge defines at least one egress aperture in fluid communication with the internal volume; and
the at least one egress aperture is configured to facilitate water egress from within the internal volume.

6. The deployable kitchen of claim 2, wherein
the movable wing defines a longitudinal axis;
the motive assembly includes a tension member;
the movable wing includes an attachment structure coupled to the outer face within an attachment range;
the motive assembly is operably coupled to the outer face of the movable wing via a removable coupling of the tension member to the attachment structure;
the attachment structure includes a radius element positioned to preclude contact between an edge of the movable wing and the tension member of the motive assembly on a condition that the tension member is removably coupled to the attachment structure;
the attachment range is centered at a midpoint of the longitudinal axis; and
the attachment range is ten percent of a maximal longitudinal length of the movable wing.

7. The deployable kitchen of claim 2, wherein:
the movable wing defines a longitudinal axis;
the movable wing includes a first lateral edge positioned orthogonal to the longitudinal axis and a second lateral edge positioned orthogonal to the longitudinal axis;
the first lateral edge defines a first cable orifice;
the second lateral edge defines a second cable orifice;
the movable wing includes a cable passage positioned within the internal volume and in fluid communication with the first cable orifice and the second cable orifice; and
the cable passage is configured to facilitate passage of a lifting cable between the first cable orifice and the second cable orifice.

8. The deployable kitchen of claim 1, further comprising:
a plurality of leveling jacks pivotably coupled to the outer face;
the plurality of leveling jacks being positioned substantially parallel to the outer face on a condition that the movable wing is at the first position;
the plurality of leveling jacks being positioned substantially orthogonal to the outer face on a condition that the movable wing is at the second position;
the movable wing includes a plurality of retention brackets coupled to the outer face; and
the plurality of retention brackets is positioned to receive the plurality of leveling jacks on the condition that the movable wing is at the first position.

9. (canceled)

10. The deployable kitchen of claim 1, further comprising:
at least one safety strap having a first end coupled to the enclosure and a second end configured to be removably coupled to the movable wing on a condition that the movable wing is at the first position, the safety strap having a length configured to establish an intermediate position of the movable wing that is between the first position and the second position.

11. The deployable kitchen of claim 1, wherein:
the first position of the movable wing is a wall position;
the movable wing is substantially orthogonal to the fixed floor when positioned at the wall position;
the outer face is configured as an exterior wall of the enclosure on a condition that the movable wing is at the wall position;
the second position of the movable wing is a floor position;
the movable wing is substantially parallel to the fixed floor when positioned at the floor position; and
the inner face is configured as a floor portion on a condition that the movable wing is at the floor position.

12. The deployable kitchen of claim 11, wherein:
the movable wing includes a first longitudinal edge and a second longitudinal edge;
the movable wing is coupled to the enclosure at the second longitudinal edge; and
the first longitudinal edge is positioned vertically above the second longitudinal edge on a condition that the movable wing is at the wall position.

13. (canceled)

14. The deployable kitchen of claim 1, wherein:
the motive assembly is a winch;
the winch is coupled to the fixed roof between the fixed roof and the fixed floor;
the fixed roof defines a longitudinal axis of the enclosure;
the winch is coupled to the fixed roof within a coupling range;
the coupling range is centered at a midpoint of the longitudinal axis of the enclosure; and
the coupling range is ten percent of a maximal longitudinal length of the enclosure.

15-17. (canceled)

18. A deployable kitchen, comprising:
an enclosure having a first configuration with a first service volume and a second configuration with a second service volume, the second service volume being greater than the first service volume, the enclosure including a fixed floor, a fixed roof, and a movable wing pivotably coupled to the fixed floor; and
a covering support assembly pivotably coupled to the fixed roof, the covering support assembly having a collapsed configuration within the first service volume on a condition that the enclosure is in the first configuration, the covering support assembly having an expanded configuration within the second service volume on a condition that the enclosure is in the second configuration.

19. The deployable kitchen of claim 18, wherein:
the covering support assembly includes a plurality of frame assemblies;
each frame assembly of the plurality of frame assemblies is pivotably coupled to the fixed roof;
each frame assembly of the plurality of frame assemblies is configured to pivot relative to the fixed roof independently of at least one other frame assembly of the plurality of frame assemblies;
the plurality of frame assemblies has a stored configuration within the first service volume on a condition that the enclosure is in the first configuration; and
the plurality of frame assemblies has a support configuration within the second service volume on a condition that the enclosure is in the second configuration.

20. The deployable kitchen of claim 19, wherein:
each frame assembly of the plurality of frame assemblies includes a movable roof segment and a support member;
the movable roof segment has an inboard end portion pivotably coupled to the fixed roof and an outboard end portion separated from the inboard end portion by a longitudinal length of the movable roof segment;
the support member includes a pivot end that is movably coupled to the outboard end portion of the movable roof segment;
the support member includes a coupling end positioned opposite the pivot end; and
the coupling end is configured to be removably coupled to the movable wing on a condition that the enclosure is in the second configuration.

21. The deployable kitchen of claim 20, wherein:
on a condition that the frame assembly is in the stored configuration:
a longitudinal axis of the support member is substantially parallel to a longitudinal axis of the movable roof segment,
a portion of the support member is retained by a securing bracket coupled to the movable roof segment, and
a ceiling face of the movable roof segment is directed toward a longitudinal midline of the enclosure; and
on a condition that the covering support assembly is in the support configuration:
the outboard end portion of the movable roof segment is vertically lower than the inboard end portion of the movable roof segment,
the longitudinal axis of the support member defines a first angle relative to the ceiling face that is greater than 90 degrees,
the longitudinal axis of the support member defines a second angle relative to the fixed floor of less than 90 degrees, and
the ceiling face of the movable roof segment is directed toward the movable wing.

22-24. (canceled)

25. The deployable kitchen of claim 20, wherein:
the inboard end portion of the movable roof segment defines a clearance passage; and
the clearance passage is configured to receive a sealing flange of the enclosure on a condition that the frame assembly is in the support configuration.

26. The deployable kitchen of claim 18, wherein:
the movable wing has an inner face separated from an outer face;
the movable wing is at a wall position and the outer face is configured as an exterior wall of the enclosure on a condition that the enclosure is in the first configuration;
the movable wing is at a floor position and the inner face is configured as a floor portion on a condition that the enclosure is in the second configuration; and
the covering support assembly is removably coupled to the inner face on a condition that the movable wing is at the floor position.

27. The deployable kitchen of claim 18, further comprising:
a foldable covering coupled between the movable wing and the fixed roof;
wherein a movable roof segment of the covering support assembly is positioned between the foldable covering and an inner face of the movable wing on a condition that the enclosure is in the second configuration.

28. The deployable kitchen of claim 27, wherein:
the foldable covering is positioned between the movable wing and the fixed roof on a condition that the enclosure is in the first configuration.

29. The deployable kitchen of claim 27, wherein:
the foldable covering is positioned between the movable wing and the covering support assembly in the collapsed configuration on a condition that the enclosure is in the first configuration.

30-34. (canceled)
